(19) United States
(12) Patent Application Publication
(10) Pub. No.: US 2011/0045778 A1
(43) Pub. Date: Feb. 24, 2011

(54) TOOTHBRUSH, AND METHOD FOR WIRELESS UNIDIRECTIONAL DATA TRANSMISSION

(76) Inventors: Martin Stratmann, Frankfurt/Main (DE); Matthias Schiebahn, Bad Camberg (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/598,554

(22) PCT Filed: Apr. 18, 2008
(86) PCT No.: PCT/EP2008/003122

§ 371 Date: Nov. 2, 2009

(30) Foreign Application Priority Data
Apr. 26, 2007 (DE) 102007020100.3

(51) Int. Cl. H04B 7/00; A46B 9/04

(52) U.S. Cl. 455/66.1; 15/167.1

(57) ABSTRACT

The invention relates to a method for wireless unidirectional data transmission between a transmitter and a receiver, wherein the transmitter sends a data set to be transmitted several times in succession on a plurality of transmission channels, and the receiver receives data sets on only one transmission channel in each case. The number of transmission channels used is smaller than the number of repetitions that the transmitter uses to transmit the data set, and a series of transmission channels is used within which the sequence of transmission channels used is prescribed. The invention further relates to a toothbrush having a transmitter for performing the method described above, and to a system comprising a toothbrush and a separate auxiliary device, wherein a transmitter is present in the toothbrush and a receiver is present in the auxiliary device. The auxiliary device comprises a display device for displaying the transmitted data.

The present invention relates to a toothbrush and to a method for wireless unidirectional data transmission between a transmitter and a receiver. This method is preferably employed in transmitting data from a small electric appliance, for example a toothbrush, to an external display device.

A shaving system is known from EP 0892701 B1, which has an electric shaver and an external device, and between them a bidirectional wireless data exchange can take place. The external device is also suitable for displaying information.

A method for transmitting data between a transmitter and a receiver over a wireless communication connection is known from DE 10332324 A1, in which the transmitter feeds the same data to be transmitted into a plurality of different transmission channels, independent of a confirmation of reception by a receiver, and in which the receiver transfers the data from a transmission channel on which they were transmitted in uncorrupted form.

A toothbrush with a display device is already known with which the charge status, for example, of a rechargeable battery built into the toothbrush is displayed. Since this display device is built into the handle of the toothbrush, the user can barely read it, if at all, while brushing his teeth.

It is the object of the present invention to disclose a toothbrush with improved utility and a simple method for wireless unidirectional data transmission with good resistance to interference.

For achieving this object, a system comprising a toothbrush and a separate auxiliary device is disclosed, in which there is a transmitter in the toothbrush and a receiver in the auxiliary device. The toothbrush has a sensor, which is coupled to the transmitter. The transmitter is designed for transmitting the data output by the sensor. The sensor detects, for example, the following operating parameters of the toothbrush: the charge status of a rechargeable battery built into the toothbrush, and/or the brushing time that has already elapsed, and/or the contact pressure with which a user presses the toothbrush against his teeth while brushing his teeth. The auxiliary device contains a receiver, for receiving the data transmitted by the transmitter, and a display device, for displaying the received data.

The method according to the invention is intended for wireless unidirectional data transmission between a transmitter and a receiver, in which the transmitter thus receives no information from the receiver regarding the correct and complete reception of the transmitted data. The method is also intended for applications in which a plurality of structurally identical transmitters and receivers can operate side by side; however, only one data transmission from a specific transmitter to a specific receiver is desired.

In the method for wireless unidirectional data transmission between a transmitter and a receiver, the transmitter sends a first data set to be transmitted multiple times in chronological succession to transmission channels that are different from one another, wherein the number of transmission channels used is less than the number of repetitions with which the transmitter transmits the first data set. The transmitter can subsequently transmit further data sets in the same way. The order of the transmission channels used by the transmitter is defined by a preferably pseudo-random sequence; that is, the transmitter successively uses the available transmission channels in the order that is predetermined by the defined sequence. A pseudo-random sequence has the advantage that it is highly likely that a plurality of transmitters using the same sequence will nevertheless not simultaneously use the same channel. Since generating a pseudo-random sequence in a microcontroller requires a great deal of computation time, the pseudo-random sequence is preferably permanently stored in memory in the transmitter. The receiver is always set to only one of the transmission channels and receives the data sets on this transmission channel and only selects the data sets that are uncorrupted from the data sets received.

The defined sequence of transmission channels preferably has the property that two transmission channels immediately succeeding one another in the sequence are different from one another, and that the length of the sequence is greater than the number of repetitions with which a data set is sent. Moreover, the sequence preferably has the property that each data set is sent at least once on each transmission channel, but no more than twice on the same transmission channel.

The method sketched above has the advantage of sufficiently great resistance to interference, with comparably little expenditure for the data transmission. Preferably, the transmission channels have different frequencies, which are distributed as uniformly as possible within the frequency band used for the data transmission; for example, one transmission channel is located in the lower range of the frequency band, another is in the middle, and a third is in the upper range of the frequency band. The transmission channels used for the data transmission are defined in the transmitter and in the receiver. So that a receiver will receive only the data that were transmitted by a specific transmitter, the identification code of the associated transmitter can be stored in memory in the receiver in an initialization phase. Naturally, it may also be provided that one receiver can receive data from a plurality of transmitters.

The receiver initially monitors only one of the defined transmission channels. Since all the data sent by the associated transmitter are sent at least once on each transmission channel, the data transmission can proceed over this one transmission channel, when reception is unimpeded. However, if the receiver detects that for a specified period of time only data it cannot use is sent on this transmission channel, it switches over to a different transmission channel. If it is able to receive uncorrupted data on this transmission channel, then it will only switch over to the next defined transmission channel, for a specified period of time, it can no longer receive any uncorrupted data, wherein this next transmission channel can also be the first transmission channel. Preferably, the receiver will select the first transmission channel again only if it has not had any unimpeded reception on any of the other transmission channels.

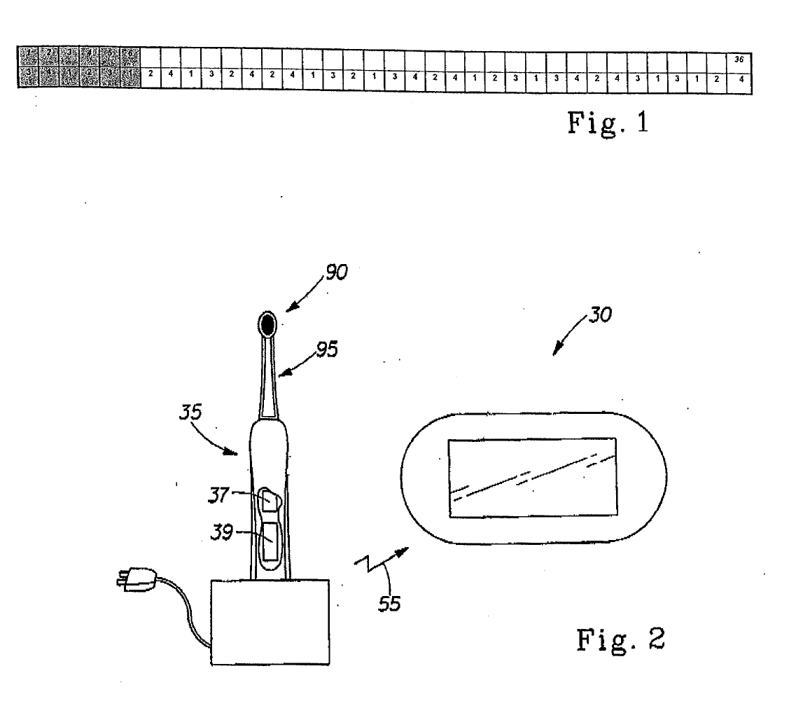

The invention will be described below in terms of an exemplary embodiment schematically shown in FIG. 2, namely in terms of an electric toothbrush 90, which has a hand part 35 with a brush attachment 95 and a separate display device 30, wherein in the hand part, data ascertained by means of a sensor 37 are intended to be transmitted wirelessly by a transmitter 39 to the display device 30, as indicated by an arrow 55. For example, the hand part detects the contact pressure with which the user presses the brush attachment against his teeth while brushing his teeth, and/or the brushing time, and/or the charge status of a rechargeable battery contained in the hand part for supplying current to the electric toothbrush. FIG. 1 shows one example of a suitable pseudo-random sequence.

The data transmission will now be described. First, a first data set is generated, which, for example, includes an identification code, time information, and/or the current contact pressure and/or the charge status. The identification code serves to identify the particular electric toothbrush individually and can for example comprise a type designation and a serial number. A number of otherwise structurally identical toothbrushes differ in their identification code, so that they can be operated in parallel without interfering with one another. This data set is sent multiple times, for example 6 times, by the transmitter in succession, wherein a plurality of transmission channels is used, for example 4 different transmission frequencies. Thus the number of repetitions with which an individual data set is sent is greater than the number of transmission channels used. The order in which the individual transmission channels are used is predetermined by a pseudo-random sequence that is permanently stored in memory in the transmitter. After that, a second data set is generated, which comprises the same identification code, a second time information, and/or a second current contact pressure and/or the current charge status, for instance. The second data set in this example is likewise sent 6 times in succession, wherein 4 different transmission channels are also used. After that, further data sets can be transmitted on a continuing basis in the same way. The pseudo-random sequence contains for example 36 elements, from which each element identifies one of the transmission channels used. In this example, the pseudo-random sequence has the property that each of the 4 transmission channels occurs at least once and no more than twice in one block of 6 successive elements, wherein successive elements are different from one another, and the order of transmission channels repeats after 6 data sets have been transmitted. In FIG. 1, the first block is shown shaded.

The receiver is tuned to only one transmission channel at a time. To achieve low current consumption, the receiver is only on as long as it needs to determine whether data intended for it have been sent on that transmission channel. If this is the case, the receiver only remains on until it no longer receives data intended for it over a specified period of time. Whether data are intended for it is decided by the receiver based on an identification code, which is stored in memory in an initializing phase and transmitted with the data by the transmitter.

The transmitter switches over to another transmission channel only when it receives data that it cannot use over a specified period of time. The decision as to whether data can or cannot be used can be made by using known methods, for example by the detection of synchronization patterns and by a checksum process.

What is claimed is:

1. A method for wireless unidirectional data transmission between a transmitter and a receiver, in which the transmitter sends a data set to be transmitted multiple times in chronological succession over a plurality of transmission channels, and the receiver receives data sets on only one transmission channel each,
characterized in that
the number of transmission channels used is less than the number of repetitions with which the transmitter transmits the data set; and that a sequence of transmission channels is employed, within which the order of the transmission channels used is predetermined.

2. The method according to claim 1,
characterized in that
two transmission channels used immediately one after the other are different from one another; and that the sequence of transmission channels includes a number of transmission channels that is greater than the number of repetitions with which a data set is sent.

3. The method according to claim 1 or 2,
characterized in that
each data set is sent at least once on each transmission channel, but no more than twice on the same transmission channel.

4. The method according to any of the previous claims,
characterized in that
the sequence is a pseudo-random sequence that is stored in memory in the transmitter.

5. The method according to any of the previous claims,
characterized in that
the receiver is tuned to only one transmission channel at a time; and that the receiver switches over to a different transmission channel if it has only received data it cannot use over a specified period of time.

6. A toothbrush having a transmitter to carry out the method according to any of claims 1 through 4.

7. The toothbrush according to claim 6,
characterized in that
it has a sensor, which is coupled with the transmitter; and that the sensor is designed for transmitting the data output by the transmitter.

8. A system comprising a toothbrush and a separate auxiliary device, wherein there is a transmitter in the toothbrush and a receiver in the auxiliary device for wireless unidirectional data transmission from the toothbrush to the auxiliary device.

9. The system according to claim 8, characterized in that the toothbrush has a sensor which is coupled with the transmitter; and that the transmitter is designed for transmitting the data output by the sensor.

10. The system according to claim 8 or 9, characterized in that the auxiliary device has a display device for displaying the data transmitted by the transmitter.
